(19) United States
(12) Patent Application Publication
(10) Pub. No.: US 2025/0038501 A1
(43) Pub. Date: Jan. 30, 2025

(54) Pest Abatement Wall Plate

(71) Applicant: Big Bug Solutions, LLC, Canton, GA (US)

(72) Inventors: Daniel Jacobson, Canton, GA (US); Thomas Satagaj, Secaucus, NJ (US)

(73) Assignee: Big Bug Solutions, LLC, Canton, GA (US)

(21) Appl. No.: 18/836,746

(22) PCT Filed: Feb. 7, 2023
(86) PCT No.: PCT/US2023/062164

§ 371 Date: Aug. 7, 2024

Related U.S. Application Data
(60) Provisional application No. 63/267,607, filed on Feb. 7, 2022.

(51) Int. Cl. H02G 3/08; A01M 1/20; A01M 1/24; H02G 3/14

(52) U.S. Cl. CPC H02G 3/081; A01M 1/20; A01M 1/24; H02G 3/14

(57) ABSTRACT

A pest abatement wall plate includes a wall plate portion structured to cover an electrical box. The wall plate portion is formed substantially from a plastic material, and it has an inner surface and an outer surface. The inner surface is adjacent to an inside volume of the electrical box when the pest abatement wall plate is deployed. The pest abatement wall plate also includes a hosting platform proximate the inner surface of the pest abatement wall plate. The hosting platform arranged to stage a pesticide. Optionally, the pest abatement wall plate further includes a mounting structure and a hinge connecting the mounting structure to the wall plate portion.

### BACKGROUND

### Technical Field

The present disclosure generally relates to abatement of pests inside a building or other structure. More particularly, but not exclusively, the present disclosure relates to reducing the presence of undesirable insects inside the building or structure.

### Description of the Related Art

FIG. 1A is a standard wall plate 10 positioned over a standard single-gang electrical box 12 that has secured therein a standard duplex electrical outlet 14. The wall plate 10 is secured by a single screw 16 through an aperture 18 (FIG. 1B) in the wall plate 10. These structures, which include the electrical box 12, electrical outlet 14, and wall plate 10, are commonly deployed in buildings and other structures for the convenience of people and for other reasons. More generically, electrical boxes of any size are desirably included in buildings and other structures, and various electrical conduits pass behind walls of the building in-to and out-from the electrical boxes. The electrical power available in such electrical boxes is useful for controlling lights, providing power to machines, and the like.

FIG. 1B is the standard single-gang electrical box 12 of FIG. 1A with the wall plate 10 removed. The standard duplex electrical outlet 14 includes a threaded receptacle 20. When the wall plate 10 is deployed, the single screw 16 (not shown in FIG. 1B) passes through the wall plate aperture 18 and rotatably cooperates with the threaded receptacle 20 to secure the wall plate to the electrical outlet 14. In this system, electrical connections of the electrical outlet 14, and in some cases other electrical conduits, are shielded from human touch. Hence, the risk of shocking humans or other animals is reduced when wall plates are used, and such wall plates are very common.

It is known that cockroaches, bedbugs, ticks, beetles (e.g., spider beetles, carpet beetles), palmetto bugs, booklice, bat bugs, and other pests can infest inside spaces, and such pests are sometimes found inside electrical boxes. Various theories suggest that electrical boxes provide heat, darkness, relative safety, electromagnetic energy, or other characteristics that attract such pests. It is further known that pests in electrical boxes leave behind waste, food, food residue, and other substances that tend to corrode or otherwise deteriorate insulation on electrical wire and other structures of the building's electrical subsystem. This deterioration can lead to electricity disruption, including fire, which is undesirable.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

The following is a summary of the present disclosure to provide an introductory understanding of some features and context. This summary is not intended to identify key or critical elements of the present disclosure or to delineate the scope of the disclosure. This summary presents certain concepts of the present disclosure in a simplified form as a prelude to the more detailed description that is later presented.

The device, method, and system embodiments described in this disclosure (i.e., the teachings of this disclosure) enable the reduction or elimination of pests such as cockroaches in areas where standard electrical fixtures are present.

In a first embodiment, a system, includes a pest abatement wall plate, that has a wall plate portion structured to cover an electrical box and a hosting platform arranged to stage a pesticide. The wall plate portion is formed substantially from a plastic material, and it has an inner surface and an outer surface. The inner surface is adjacent to an inside volume of the electrical box when the pest abatement wall plate is deployed. The first embodiment also includes a hosting platform proximate the inner surface of the pest abatement wall plate.

In some cases of the first embodiment, the pest abatement wall plate further includes a mounting structure and a hinge connecting the mounting structure to the wall plate portion.

In the first embodiment, the wall plate portion may be arranged for placement about a standard duplex electrical outlet or the wall plate portion may be for placement about a standard single pole toggle switch. Alternatively, the wall plate portion may be arranged for placement about a standard rectangular electrical fixture.

Also in some cases of the first embodiment, optionally, the electrical box may be a single-gang electrical box or a multi-gang electrical box. The hosting platform is arranged as a well in some embodiments, and in other embodiments, the hosting platform is arranged as a protuberance having a substantially planar surface that is substantially perpendicular to the inner surface of the wall plate portion. In at least some cases, the hosting platform and the wall plate portion are formed as a single structure.

In some cases where the pest abatement wall plate further includes a mounting structure and a hinge connecting the mounting structure to the wall plate portion. In some of these cases, the mounting structure has single aperture arranged to receive a screw, and the screw is arranged to secure the mounting structure to a central portion of a standard duplex outlet. Sometimes, the mounting structure includes a first substructure having a first aperture arranged to receive a first screw and a second substructure having a second aperture arranged to receive a second screw. In these and optionally other cases, the first and second screws are arranged to secure the mounting structure to first and second portions of an electrical switch. The mounting structure is formed substantially from metal in some cases, and in other cases, the mounting structure is formed substantially from a plastic.

Considering some other cases of the first embodiment, the hosting platform may be integrated with, or connected to, the mounting structure. Optionally, the hinge may be a piano hinge or a living hinge structure. In at least some cases of the first embodiment, the hinge is a living hinge, and sometimes, the mounting structure and the hinge are formed as a single structure.

In a second embodiment, a pest abatement wall plate includes a wall plate means structured to cover an electrical box. The wall plate means has an inner surface and an outer surface, and the inner surface is adjacent to an inside volume of the electrical box where the wall plate means is deployed. A hosting platform means is also included in the second embodiment proximate the inner surface of the pest abatement wall plate. The hosting platform is arranged to a stage a pesticide.

In a third embodiment, a method of pest abatement includes the acts of securing a mounting structure of a pest abatement wall plate to an electrical fixture that is mounted in an electrical box; applying a pesticide to a hosting platform of the pest abatement wall plate; and rotating a wall plate portion of the pest abatement wall plate to close the pest abatement wall plate and cover an open area of the electrical box.

This Brief Summary has been provided to describe certain concepts in a simplified form that are further described in more detail in the Detailed Description. The Brief Summary does not limit the scope of the claimed subject matter, but rather the words of the claims themselves determine the scope of the claimed subject matter.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1A is a standard wall plate positioned over a standard single-gang electrical box that has secured therein a standard duplex electrical outlet;

FIG. 1B is the standard single-gang electrical box of FIG. 1A with the wall plate removed;

FIG. 2 is a room in a building as viewed from inside of the room;

FIG. 3 is a first embodiment of a pest abatement wall plate;

FIG. 4 is a second embodiment of a pest abatement wall plate;

FIGS. 5A and 5B are third and fourth embodiments of pest abatement wall plates;

FIGS. 6A-6C are additional embodiments of pest abatement wall plates;

FIGS. 7A-7I are a variety of wall plate portions;

FIGS. 8-10 are additional embodiments of pest abatement wall plates

FIGS. 11A-11B are an embodiment of a pest abatement wall plate having an access door portion; and

FIGS. 12A-12E are embodiments of access door portions.

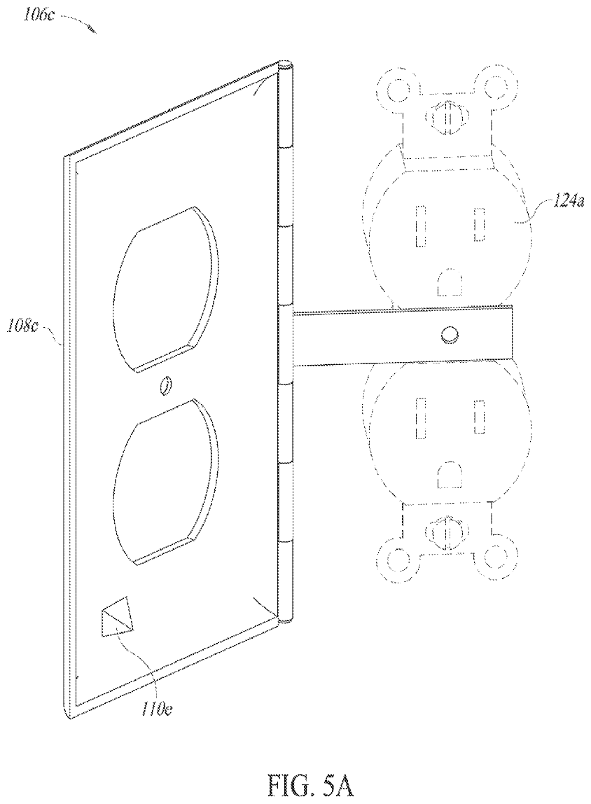

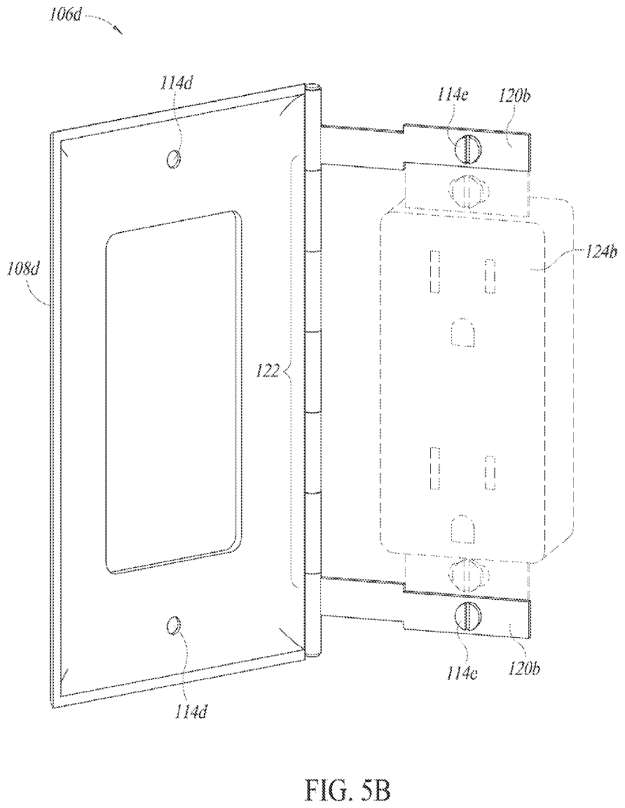

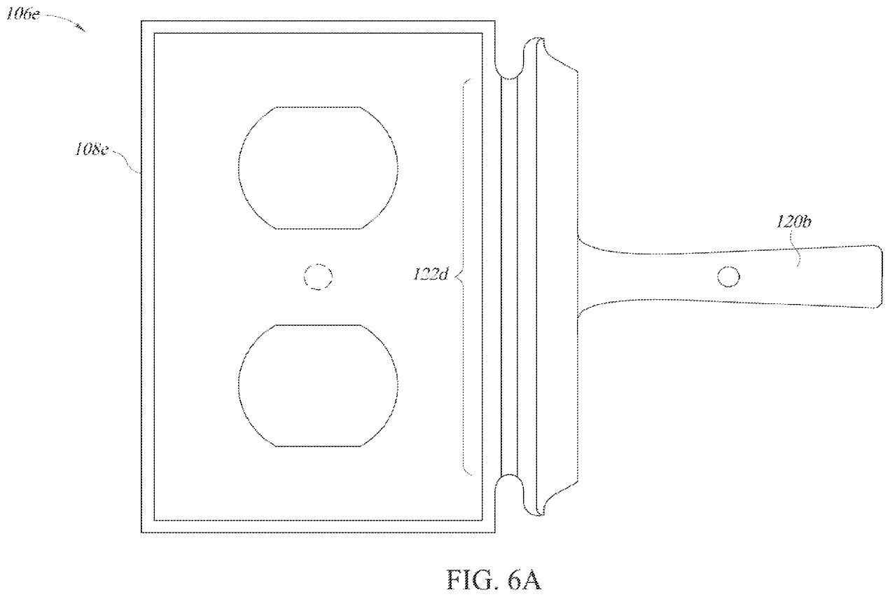

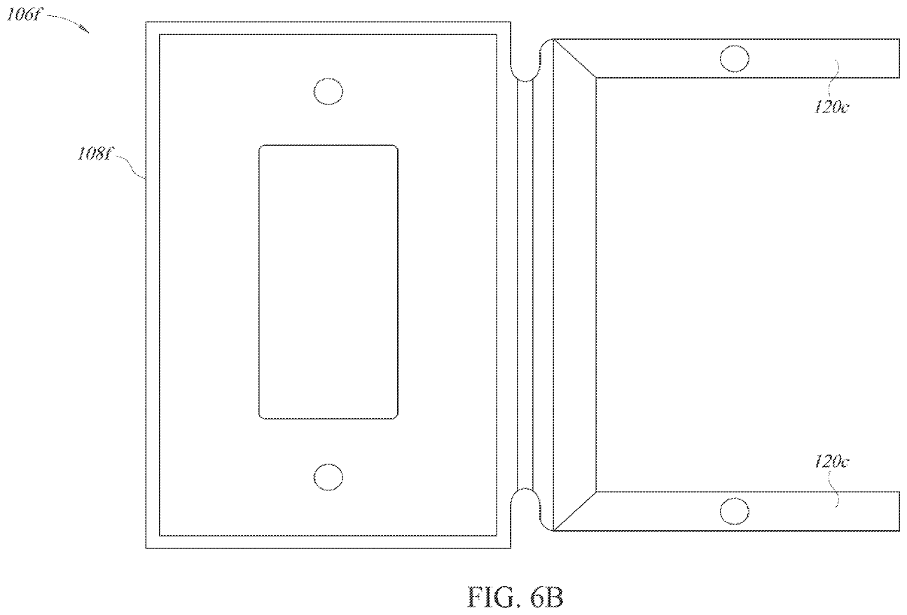

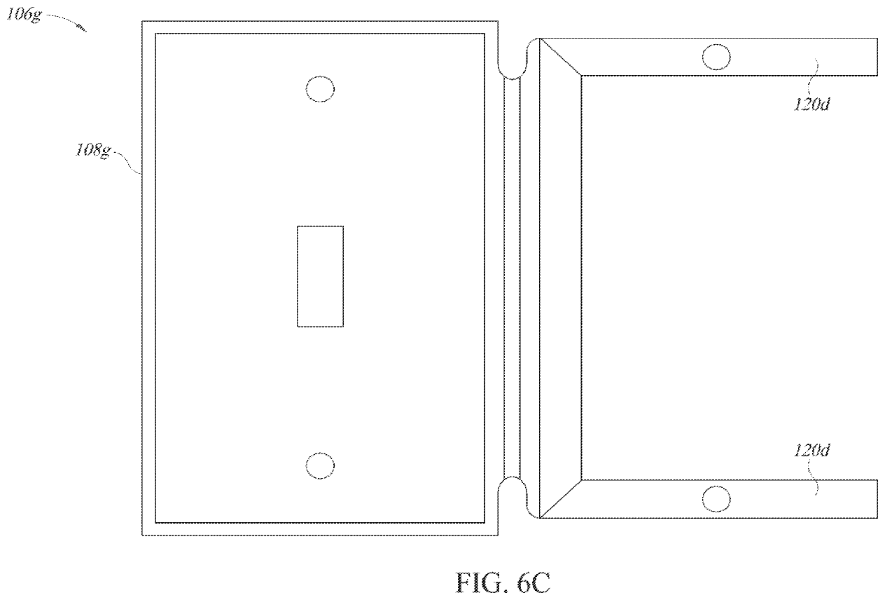

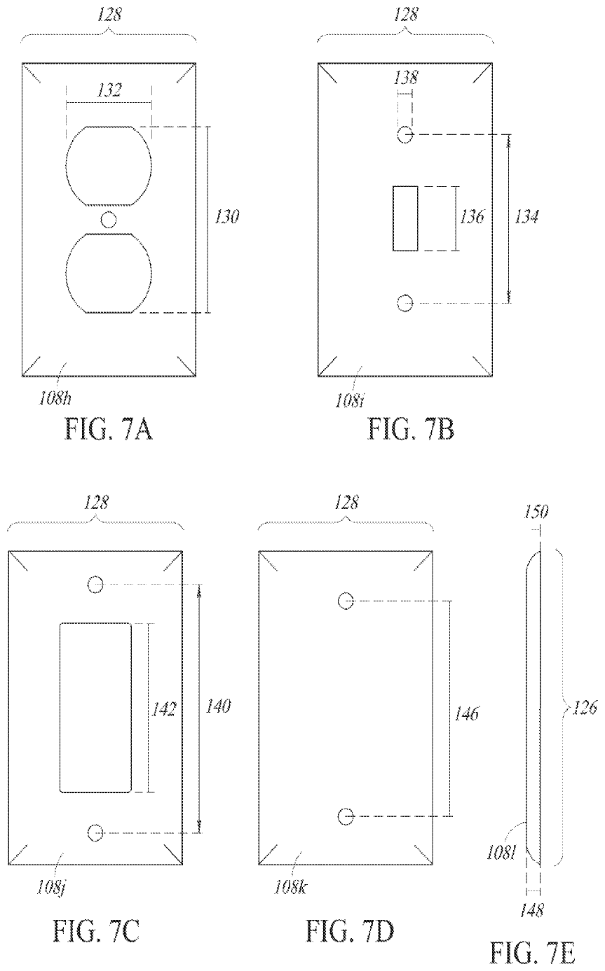

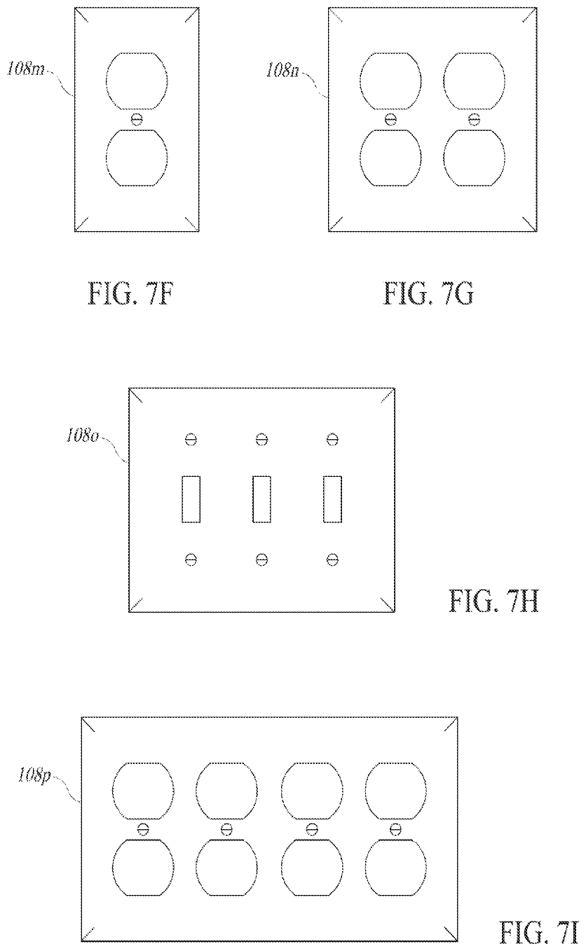

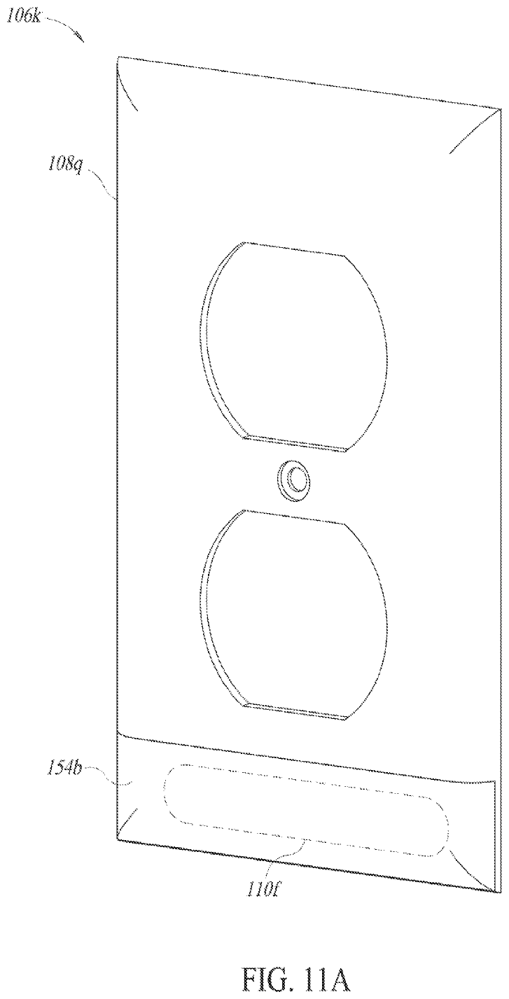

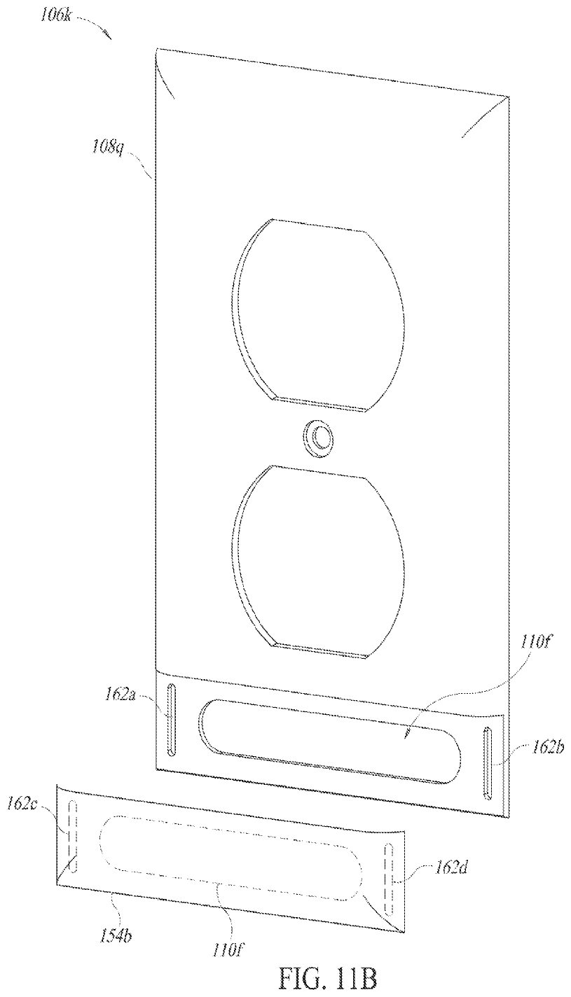

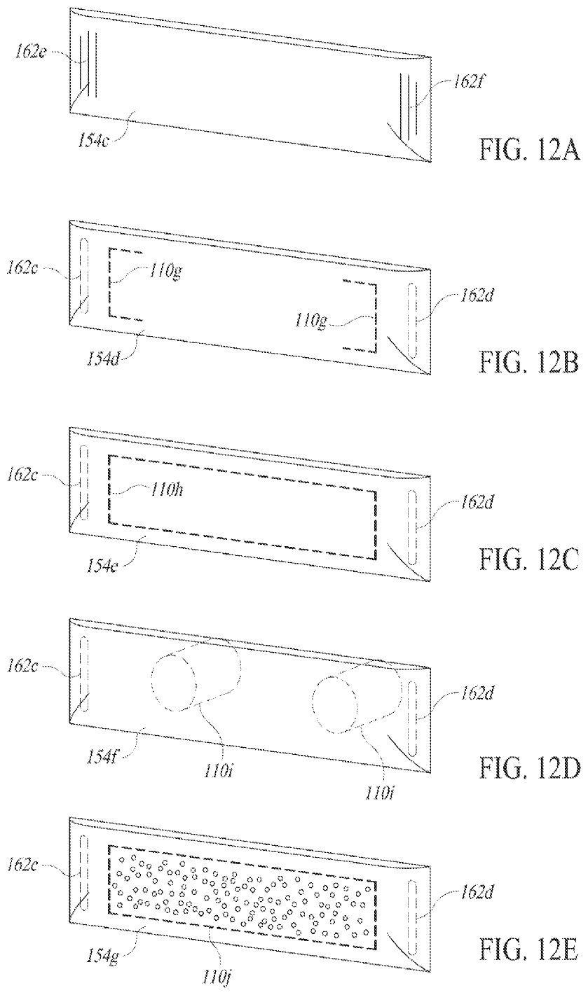

In the present disclosure, for brevity, certain sets of related figures may be referred to as a single, multi-part figure to facilitate a clearer understanding of the illustrated subject matter. For example, FIGS. 5A-5B may be individually or collectively referred to as FIG. 5. FIGS. 6A-6C may be individually or collectively referred to as FIG. 6. FIGS. 7A-7I may be individually or collectively referred to as FIG. 7. FIGS. 11A-11B may be individually or collectively referred to as FIG. 11. And FIGS. 12A-12E may be individually or collectively referred to as FIG. 12. Structures earlier identified may not be repeated for brevity.

### DETAILED DESCRIPTION

The present disclosure may be understood more readily by reference to this detailed description and the accompanying figures. The terminology used herein is for the purpose of describing specific embodiments only and is not limiting to the claims unless a court or accepted body of competent jurisdiction determines that such terminology is limiting. Unless specifically defined in the present disclosure, the terminology used herein is to be given its traditional meaning as known in the relevant art.

In the following description, certain specific details are set forth in order to provide a thorough understanding of various disclosed embodiments. However, one skilled in the relevant art will recognize that embodiments may be practiced without one or more of these specific details, or with other methods, components, materials, and the like. In other instances, certain structures associated with electrical components such as electrical boxes, electrical conduit, switches, outlets, jacks, ports, and the like have not been shown or described in detail to avoid unnecessarily obscuring more detailed descriptions of the embodiments.

The device, method, and system embodiments described in this disclosure (i.e., the teachings of this disclosure) include wall plate structures that enable the abatement of undesirable pests (e.g., insects) inside the building or structure.

An embodiment of the present invention includes a pest abatement wall plate having a wall plate portion structured to cover an electrical box. The electrical box is, for example, integrated or otherwise mounted in a wall of a room. The wall plate portion is formed substantially from a plastic material, but other materials are of course contemplated. The pest abatement wall plate wall plate has an inner surface and an outer surface; the inner surface being adjacent to an inside volume of the electric box when the pest abatement wall plate wall plate is deployed, and the outer surface being exposed into the room where the electric box is located. In this embodiment, a hosting platform is proximate the inner surface of the pest abatement wall plate. That is, the hosting platform is nearby, close to, adjacent, joined with, integrated within, affixed thereto, formed thereon, or realized in some other way in the space behind the wall plate portion. In some cases, a hosting platform is formed or otherwise realized on an inside surface of a wall plate portion, and in other cases, the hosting platform is formed or otherwise realized on a support structure or other portion of a pest abatement wall plate system.

In an exemplary case, set forth in a non-limiting descriptive way merely to demonstrate one embodiment, the pest abatement wall plate also includes a mounting means that is connected to the wall plate portion via a hinge means. When the pest abatement wall plate wall plate is deployed, the mounting means is affixed (e.g., screwed, clipped, or coupled in some other way) to the electrical box or an electrical component (e.g., switch, outlet, or the like) mounted in the electrical box. Once affixed, the wall plate portion of the pest abatement wall plate structure may be rotated about the integrated hinge means to cover both the mounting means and the inside volume of the electrical box. In at least one case, the wall plate portion operates like the cover of a book wherein a first side of the hinge means is integrated with an elongated vertical edge of the wall plate portion, and the second side of the hinge means integrated with the mounting means. Hence, the wall plate portion can be easily opened (e.g., like the cover of the book) to expose the inner surface of the wall plate portion and the inner volume of the electrical box for the deposition of pesticide.

Turning to the remainder of this Detailed Description, the present invention may be understood more readily by reference to this detailed description of the invention. The terminology used herein is for the purpose of describing specific embodiments only and is not limiting to the claims unless a court or accepted body of competent jurisdiction determines that such terminology is limiting. Unless specifically defined herein, the terminology used herein is to be given its traditional meaning as known in the relevant art.

Prior to setting forth the embodiments however, it may be helpful to an understanding thereof to first set forth definitions of certain terms that are used hereinafter.

The terms “abate” and “abatement” are used, in all their grammatical forms, throughout the present specification and claims to refer to any reduction, lessening, subsidence, dwindling, declination, diminution, attenuation, and the like, up to and including a total eradication.

A “pest” refers to an undesirable living entity that is often, but not always, an insect. A non-limiting, non-exhaustive list of pests targeted in the present specification and claims includes cockroaches, bedbugs, ticks, beetles (e.g., spider beetles, carpet beetles), palmetto bugs, booklice, bat bugs, termites (subterranean termites, drywood termites, Formosan termites, and the like), parasites, and other pests that can infest inside spaces. Pests are not limited to insects, and other pests (e.g., spores, bacteria, germs, and the like) are of course contemplated.

A “hosting platform” is a physical structure or portion of a physical structure that is arranged to stage a pesticide. A non-limiting, non-exhaustive list of hosting platform types includes those arranged as a distinct planar surface, a pocket, a bowl, a compartment, an aperture, a protrusion, a protuberance, or some other hosting platform means suitable to stage a pesticide. In some cases, a hosting platform includes a particular portion of a structure that is specifically designated for staging a pesticide. Such designation may be by marking (e.g., ink, paint, cathodic reaction, burning, or the like) or by physical identification (e.g., embossment, etching, trenching, carving, scratching, or the like) or by some other clear indicator.

A “pesticide” is a means for eradicating or at least reducing the undesirable effects of a pest; and “eradicating” (or to “eradicate”) means to kill, eliminate, annihilate, repel, get rid of, remove, do away with, root out, uproot, suppress, destroy, exterminate, extinguish, weed out, stamp out, wipe out, crack down on, abolish, erase, obliterate, efface, expunge, extirpate, or the like. Eradicating a pest includes, but is not limited to, causing the death of the pest. That is, eradicating a pest also includes disrupting the normal course of behavior of the pest, which includes, but is not limited to, encouraging the pest to relocate or otherwise vacate the area in, and proximate to, the area where the pesticide is located. As the term is used in the present specification and claims, a pesticide may be, or otherwise take the form of, a liquid, a solid, a powder, a spray, an aerosol, an adhesive, a gel, a paste, a solution, a particulate, pellets, granules, an impregnated material, or any other known form. As the term is used in the present specification and claims, a pesticide may be or otherwise include an attractant, a bait, a food source, a poison, an irritant, an annoyance, and the like. In some cases, a pesticide will eradicate a pest directly; in other cases, the pesticide may also be or include an ovicide, a larvicide, or a substance that targets some other area of a pests' life cycle. In still other cases, a pesticide may be used to attract one or more pests to enable a human or a machine (e.g., electronic machine, mechanical machine, electromechanical machine, or the like) detect the presence of one or more pests. A pesticide, as contemplated herein, may be or include a single substance or a combination of substances. A non-limiting, non-exhaustive list of pesticides include Geraniol, Fipronil, Abamectin, an Organochloride (e.g., DDT, Aldrin, Dieldrin, Endrin, Heptachlor, or some other chlorinated hydrocarbon), an Organophosphate (e.g., Bensulide, Chlorpyrifos, Diazinon, Dimethoate, Phosalone, Phosmet, Trichlorfon, or the like), a Carbamate (e.g., Aldicarb, Bendiocarb, Carbaryl, Methomyl, or the like), a Pyrethroid (e.g., Chrysanthemum, Tanacetum, Tetramethrin, or the like), pyrethrin, a Neonicotinoid (e.g., nicotine, Imidacloprid, Acetamiprid, Thiaclopridor or the like), a Butenolide (e.g., flupyradifurone), a Ryanoid/diamide (e.g., ryanodine, Rynaxypyr, chlorantraniliprole, or the like), fipronil, hydramethylnon, indoxacarb, mineral oil, caffeine, citronellol, ivermectin, avermectin, menthol, oregano, butyl lactate, isopropyl myristate, triethyl citrate, isopropyl alcohol, a borate such as boric acid, diatomaceous earth, and a biological (e.g., Bacillus sphaericus, granulovirus, and the like). Also within contemplation of the present disclosure, a pesticide may be bait or include a bait such as, but not limited to, a sugar, a sap, a salt, a chemical (e.g., nitrogen), particular type of wood or wood product, and the like.

A “living hinge” is a type of hinge made from an extension of some material (e.g., polypropylene plastic) of a parent material. The living hinge is one or more thin sections of plastic that act as a connection between two larger sections. In some embodiments, the larger parent material pieces and the bridge between them (i.e., the living hinge) will be made of one continuous piece of material. Since the living hinge is very thin and typically made from flexible material (e.g., polypropylene), the living hinge is also able to rotate about one axis to any suitable dimension (e.g., about one-hundred-eighty (180) degrees or more), potentially for millions of cycles, without breaking. Contrary to most other hinges which involve multiple parts assembled in a traditional mechanism, living hinges are not a separate structure.

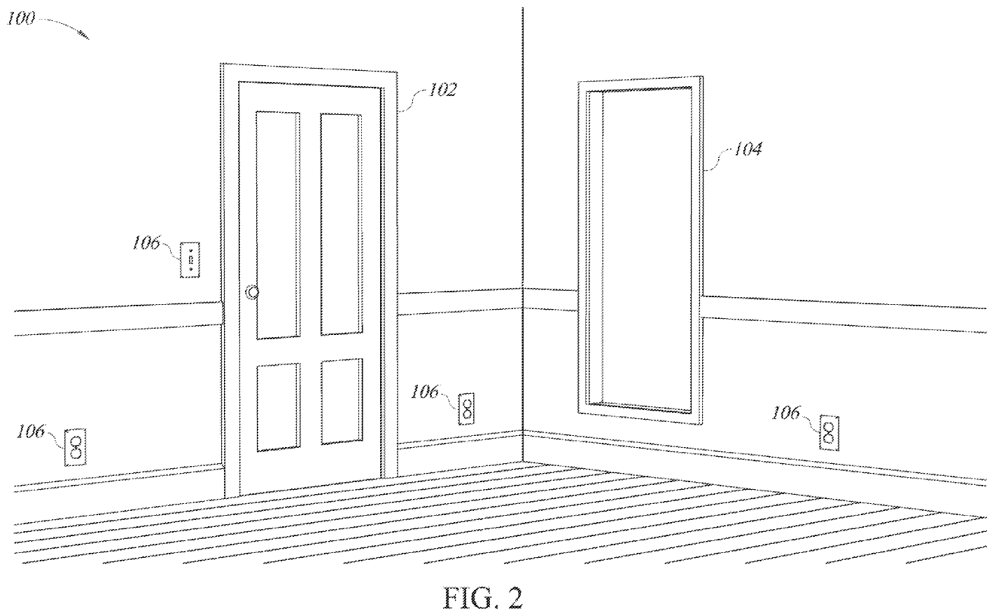

FIG. 2 is a room 100 in a building as viewed from inside of the room 100 looking toward a corner of the room 100. A door 102 is constructed through a first wall of the room 100, and a window 104 is constructed through a second wall of the room 100. Sometimes, pests move through one or more parts of the building. Pests can ingress or egress the room 100 via electrical fixtures (e.g., switches, outlets, cable ports, and the like) that are constructed in walls of the room 100. To abate the pests, various pest abatement wall plates 106 are installed over at least some of the electrical fixtures in the room. In FIG. 2, four pest abatement wall plates 106 are identified. In other embodiments, any suitable number of pest abatement wall plates 106 may be deployed.

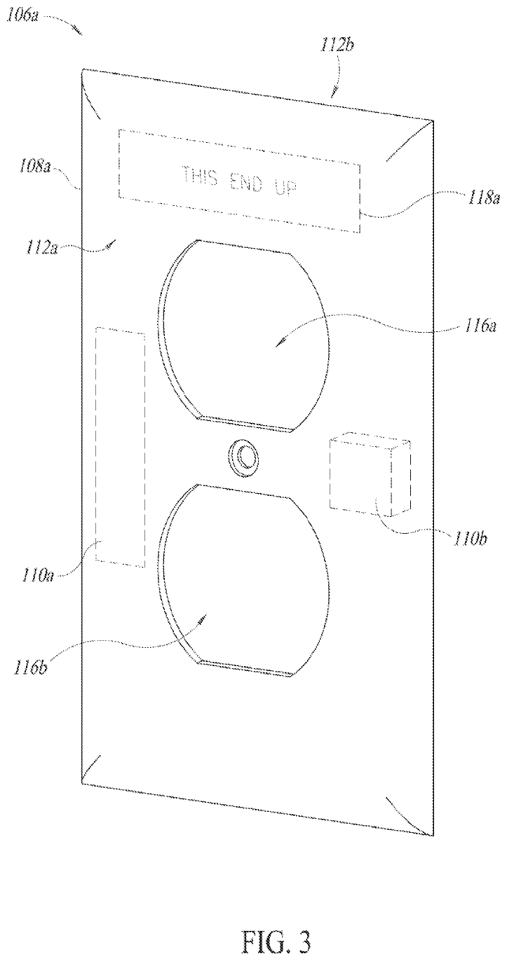

FIG. 3 is a first embodiment of a pest abatement wall plate 106a. The pest abatement wall plate 106a includes a wall plate portion 108a and at least one pesticide hosting platform 110a, 110b. The embodiment of FIG. 3 includes an optional first pesticide hosting platform 110a and an optional second pesticide hosting platform 110b, but other pest abatement wall plate embodiments may have one pesticide hosting platform, three pesticide hosting platforms, or some other number of pesticide hosting platforms. The wall plate portion 108a has an inside surface 112a and an outside surface 112b. The wall plate portion 108a is arranged to cover a standard electrical duplex outlet in a single-gang electrical box, and when deployed, the inside surface 112a is adjacent the inside volume of the single-gang electrical box, and the outside surface 112b is facing the room 100 (FIG. 2) in which the pest abatement wall plate 106a is deployed.

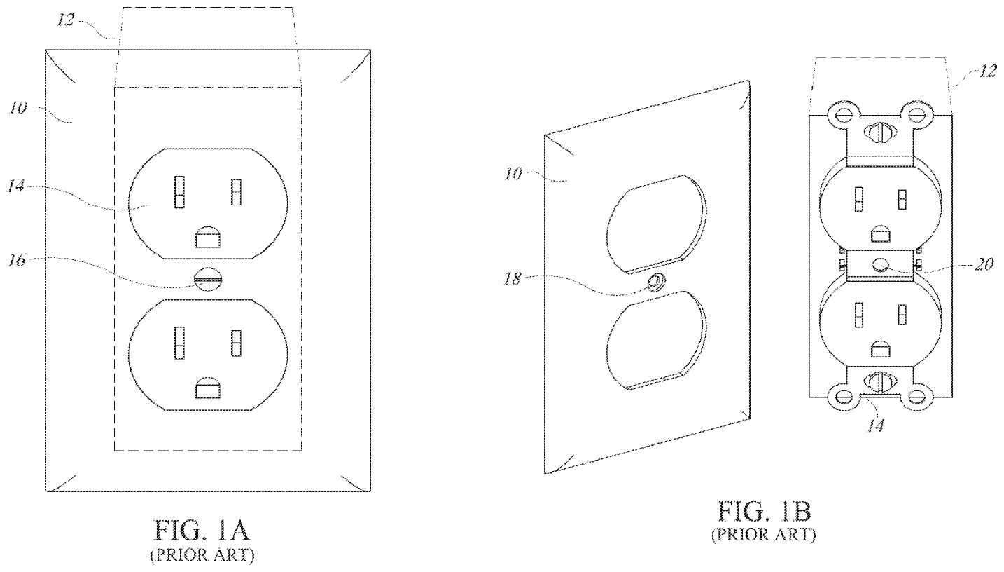

The wall plate portion 108a of the first embodiment of a pest abatement wall plate 106a includes a wall plate securing structure 114a. The wall plate securing structure 114a may be arranged as, or including, an aperture, a magnet, a stud, a hook-and-loop structure, an adhesive, or some other securing means. Generally, the securing structure 114a secures, or helps to secure, the wall plate portion 108a of the pest abatement wall plate 106a in place, over the standard electrical duplex outlet, and covering the otherwise exposed areas of the single-gang electrical box. When the pest abatement wall plate 106a is deployed, the duplex outlet receptacles are exposed in the room 100 (FIG. 1) via first and second apertures for the electrical fixture 116a, 116b, and the pesticide hosting platforms 110a, 110b are adjacent the inside volume of the single-gang electrical box where they cannot be accessed by people, pets, or other living things inside the room 100 (FIG. 1).

In cases where the wall plate securing structure 114a is an aperture, the act of securing the pest abatement wall plate 106a is performed along the lines of a known standard wall plate 10A (FIG. 1). That is, a screw or some other screw-like structure is passed through the wall plate securing structure 114a (i.e., an aperture in this embodiment) and rotated or otherwise advanced into the standard electrical duplex outlet (not shown). When secured, the pesticide hosting platforms 110a, 110b are adjacent the inside volume of the electrical box, and the duplex outlet receptacles are exposed in the room 100 (FIG. 1) via first and second apertures for the electrical fixture 116a, 116b. When it is time to reapply pesticide, the screw or screw-like structure is reversed out from the standard electrical duplex outlet, the pest abatement wall plate 106a is removed, and pesticide is re-applied to one or more hosting platforms 110a, 110b.

In other cases, for example when the wall plate securing structure 114a is arranged as a magnet, the act of securing the pest abatement wall plate 106a is performed by aligning the duplex outlet receptacles through the first and second apertures for the electrical fixture 116a, 116b, and advancing the pest abatement wall plate 106a toward the standard electrical duplex outlet (not shown). Optionally, an orientation means 118a may be included, for example, to help align the pest abatement wall plate 106a and avoid “spilling” pesticide powder or liquid. The wall plate securing structure 114a (i.e., a magnet in this embodiment) will engage with, and adhere to, a screw head, stud, or other ferrous object positioned on or in a central portion of the standard electrical duplex outlet. When a reapplication of pesticide is desired, the pest abatement wall plate 106a can simply be “pulled” back from its previous position about the standard electrical duplex outlet. In this way, the reapplication of pesticide on an electrical-box-facing-portion of the pest abatement wall plate 106a is very fast and easy.

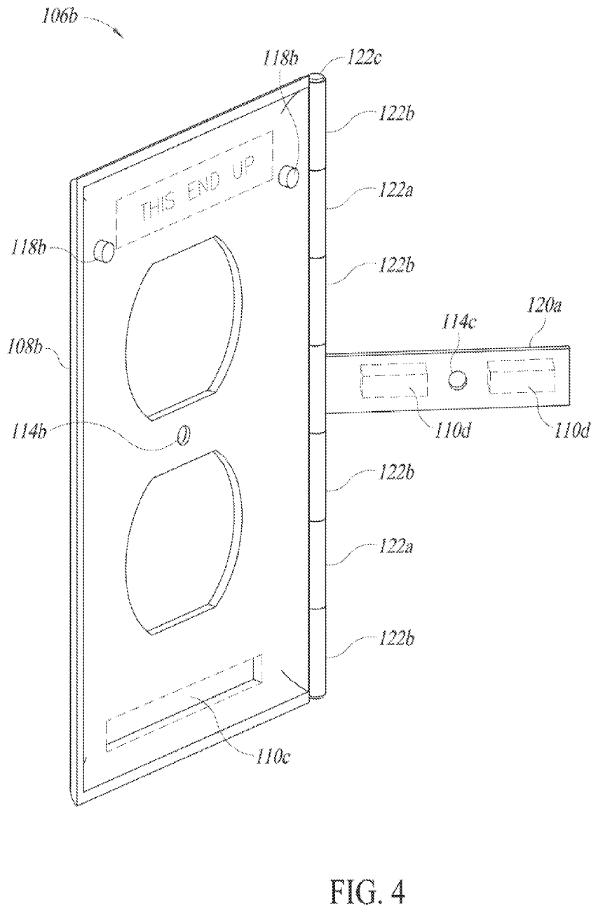

FIG. 4 is a second embodiment of a pest abatement wall plate 106b. Along the lines of the pest abatement wall plate 106a of FIG. 3, the pest abatement wall plate 106b includes a wall plate portion 108b and at least one pesticide hosting platform 110c, 110d. Certain features of pest abatement wall plate 106a are also present in pest abatement wall plate 106b, but these features are not expressly identified to reduce the likelihood of cluttering or obfuscating other features of the present figure or otherwise confusing the disclosure.

The pest abatement wall plate 106b embodiment of FIG. 4 includes a mounting structure 120a and a hinge connecting the mounting structure 120a to the wall plate portion 108b. The hinge of FIG. 4 is a piano hinge, but other hinge structures are also contemplated (e.g., barn hinges, living hinges, continuous hinges, strap hinges, cabinet hinges, butt hinges, or another suitable type of hinge).

The mounting structure 120a may be about one-quarter inch (0.25 in.) wide, about three and one-half inches (3.5 in.) long and about one-sixteenth inch (0.0625 in.) thick. The mounting structure 120a may be formed of a plastic, a metal, a composite material, or some other suitable material. The mounting structure may include a wall plate securing structure 114c that is arranged as an aperture that will receive a screw or screw-like structure. Additionally, or alternatively, the wall plate securing structure 114c may be arranged as a screw, post, or some other mechanism to couple the pest abatement wall plate 106b to the electrical device (e.g., a standard electrical duplex outlet).

In some embodiments, the mounting structure is less than one-quarter inch (0.25 in.) wide, and in other embodiments, the mounting structure is more than one-quarter inch (0.25 in.) wide. Sometimes, the mounting structure is between about one-eighth inch (0.125 in.) wide and one inch (1 in.) wide.

In some embodiments, the mounting structure is less than three and one-half inches (3.5 in.) long, and in other embodiments, the mounting structure is more than three and one-half inches (3.5 in.) long. Sometimes, the mounting structure is between about three-fourths of an inch (0.75 in.) long and about twelve inches (12 in.) long.

In some embodiments, the mounting structure is less than one-sixteenth inch (0.0625 in.) thick, and in other embodiments, the mounting structure is more than one-sixteenth inch (0.0625 in.) thick. Sometimes, the mounting structure is between about 1/32 inch (0.03125 in.) thick and about one-half inch (0.5 in.) thick.

Optional third and fourth pesticide hosting platforms 110c, 110d are proximate the inner surface of the pest abatement wall plate 106b. Both the third and fourth pesticide hosting platforms 110c, 110d are arranged as “shelf-style” protuberances coupled to, or integrated with, some portion of the pest abatement wall plate 106b. Each pesticide hosting platform has a substantially planar surface that is substantially perpendicular to the inner surface 112a of the wall plate portion 108b.

The hinge of FIG. 4 includes a first plurality of hinge barrels 122a intermeshed with a second plurality of hinge barrels 122b. One or more of the first plurality of hinge barrels 122a are coupled to the mounting structure 120a, and one or more of the second plurality of hinge barrels 122b are coupled to the wall plate portion 108b. A hinge pin 122c passes through the hinge barrels 122a, 122b, which permits the wall plate portion 108b to pivot about the hinge. In this way, the wall plate portion 108b may be operated like the cover of a book. When the wall plate portion 108b is “open,” pesticide may be easily applied to a pesticide hosting platform 110c, 110d. When the wall plate portion 108b is “closed,” then humans, pets, and others may be protected from contact with the pesticide.

In some cases, the pest abatement wall plate 106b is preferably oriented in a particular direction. To assist in such task, a pest abatement wall plate 106b may include an orientation means 118a, 118b. The orientation means may be arranged for visual observation (e.g., a marking, etching, inking, staining, coloring, or the like), or the orientation means may be arranged for tactile use (e.g., boss, fiducial, cooperative protuberances and recesses, and the like). Accordingly, in some cases, a user of the pest abatement wall plate 106b may be expected to observe a correct orientation using the included orientation means 118a, 118b as a visual guide. Additionally, or alternatively, the orientation means 118b may be arranged for physical mating, inter-linking, attracting, or some other form of physical cooperation.

In cases where the wall plate securing structure 114c is an aperture, the act of securing the pest abatement wall plate 106a is performed by passing a screw or some other screw-like structure through the wall plate securing structure 114c (i.e., an aperture in this embodiment) and rotating or otherwise advancing the screw or screw-like structure into the standard electrical duplex outlet (not shown). The screw or screw-like structure may have an exposed portion that is arranged for removable affixation to the wall plate securing structure 114c or the screw or screw-type structure that passes through the wall plate securing structure 114c. For example, in some cases, the wall plate securing structure 114b may be arranged as a magnet, and the wall plate securing structure 114c is arranged as an aperture that receives a steel screw.

When the mounting structure 120a is secured to a standard electrical duplex outlet, the wall plate portion 108b may be rotated to a closed position such that the pesticide hosting platforms 110c, 110d are adjacent the inside volume of the electrical box. Conversely, the wall plate portion 108b may be rotated to an open position such that the pesticide hosting platforms 110c, 110d are accessible for the application of pesticide.

FIGS. 5A and 5B are third and fourth embodiments of pest abatement wall plates 106c, 106d, respectively. The third embodiment of a pest abatement wall plate 106c is along the lines of the second embodiment of a pest abatement wall plate 106b (FIG. 4). To assist in an understanding of certain inventive concepts disclosed herein the third embodiment of a pest abatement wall plate 106c is illustrated as secured to an electrical fixture 124a, which is arranged as a standard electrical duplex outlet. In addition, the third embodiment of a pest abatement wall plate 106c also includes a hollow, generally pyramidical pesticide hosting platform 110e, which acts as a reservoir (e.g., well, repository, cistern, vat, basin, container, receptacle, holder, tank, or the like) for pesticide.

FIG. 5B, which is the fourth embodiment of a pest abatement wall plate 106d described in the present disclosure, is along the lines of the third embodiment of a pest abatement wall plate 106c, albeit with a different wall plate portion 108d joined to a different mounting structure 120b by a hinge 122. Pest abatement wall plate 106d includes at least one pesticide hosting platform of a type contemplated herein, but no such platform is shown to simplify an understanding of the fourth embodiment of a pest abatement wall plate 106d.

Wall plate portion 108d is arranged to cover a single-gang electrical box that supports a standard rectangular electrical fixture, which may be configured as one or more electrical outlets, a rocker switch, a toggle switch, a cable jack, a phone jack, a low voltage video port (e.g., high-definition multimedia interface (HDMI), DisplayPort, or some other video protocol) of any desirable type, or some other electrical fixture. An electrical fixture 124b is shown in dashed-line relief to communicate how first and second mounting structures 120b of the pest abatement wall plate 106d are deployed. The electrical fixture 124b is configured as a standard rectangular electrical duplex outlet, but other types of electrical fixtures are of course contemplated. In this case, the electrical fixture 124b is mounted in a standard single-gang electrical box, and first and second mounting structures 120b are coupled to the electrical fixture via first and second wall plate securing structures 114e. In the fourth embodiment of a pest abatement wall plate 106d, two pairs of mounting structures 114d, 114e cooperate along the lines of a single pair of mounting structures 114b, 114c (FIG. 4). In at least some cases, the inside surface of wall plate portion 108d may include magnets, hook-and-loop structures, an adhesive, or some other mounting structures 114d. Correspondingly, the outside surface of wall plate portion 108d may include an illusory (e.g., false, fake, or the like) screw head. In this way, wall plate portion 108d may appear to be a standard wall plate along the lines of prior art wall plate 10 of FIG. 1.

FIGS. 6A-6C are additional embodiments of pest abatement wall plates 106e-106g, respectively, arranged to cooperate with known standard electrical fixtures. For example, wall plate portion 108e (FIG. 6A) is arranged to expose the receptacles of a standard electrical duplex outlet, wall plate portion 108f is arranged to expose the active structure of a standard rectangular electrical fixture, and wall plate portion 108g is arranged to expose the toggling member of a standard electrical toggle switch.

Each of abatement wall plates 106e-106g includes an integrated living hinge 122d. To avoid cluttering the figures, the living hinge 122d is identified only in FIG. 6A, however, the living hinge is also evident in FIGS. 6B, 6C too. The living hinges 122d in these embodiments are formed from an extension of the respective wall plate portion 108e-108g parent material. In at least some cases, the wall plate portion, the mounting structures, and living hinge are formed as a single structure from a single piece of material, which may be a type of plastic (e.g., polypropylene). The wall plate portion and the mounting structures are typically larger, thicker sections of material, and the living hinge is arranged as a thinner bridge between them. In at least some cases, the wall plate portion has a generally rectangular shape with parallel long edges, and parallel short edges; and the living hinge extends across more than one-half of a long edge and less than three-fourths of the long edge. Such arrangement permits the wall plate portion and the mounting structures to have acceptable levels of rigidity and the hinge to have acceptable levels of flexibility and durability.

FIGS. 7A-7I are a variety of wall plate portions 108h-108p arranged as integral structures of one or more pest abatement wall plates.

FIG. 7A is a wall plate portion 108h structured to expose a duplex electrical outlet. The wall plate portion 108h has a first dimension 126 (i.e., height) of between about four inches (4 in.) and about five inches (5 in.). In at least one exemplary case, the wall plate portion 108h has a first dimension 126 (i.e., height) of about four and one-half inches (4.5 in.). The wall plate portion 108h has a second dimension 128 (i.e., width) of between about two inches (2 in.) and about four inches (4 in.). In at least one exemplary case, the wall plate portion 108h has a second dimension 128 (i.e., width) of about two and three-fourths inches (2.75 in.). The wall plate portion 108h has a third dimension 130 (i.e., height of the duplex) of between two and one-half inches (2.5 in.) and about three inches (3 in.). In at least one exemplary case, the wall plate portion 108h has a third dimension 130 of about two and two-thirds inches (2.66 in.). The wall plate portion 108h has a fourth dimension 132 (i.e., width of duplex) of between about one and one-quarter inches (1.25 in.) and about two inches (2 in.). In at least one exemplary case, the wall plate portion 108h has a fourth dimension 132 of about one and one-third inches (1.33 in.).

FIG. 7B is a wall plate portion 108i structured to expose a standard single pole toggle switch. FIG. 7C is a wall plate portion 108j structured to expose a standard rectangular electrical device such as a duplex outlet, a rocker switch, a cable port, a telephone port, or the like. FIG. 7D is a wall plate portion 108k structured as a wall plate blank to cover an open electrical box. And FIG. 7E is a wall plate portion 108l that may be any type of wall plate as directly or indirectly described in the present disclosure. Each of the wall plate portions 108i, 108j, 108k, 1081 may have a first dimension 126 (i.e., height) as described with respect to the wall plate portion 108h of FIG. 7A. Each of wall plate portions 108i, 108j, and 108k may have a second dimension 128 (i.e., width) as described with respect to wall plate portion 108h of FIG. 7A. Wall plate portion 108l may have a width sufficient to cover a single-gang electrical box, a two-gang electrical box, a three-gang electrical box, or any other electrical box.

Turning back to FIG. 7B, the wall plate portion 108i has a third dimension 134 (i.e., height between mounting screws) of about two and one-half inches (2.5 in.), but other suitable dimensions are also contemplated. The wall plate portion 108i has a fourth dimension 136 (i.e., height of aperture to expose toggle switch) of about one inch (1 in.), but other suitable dimensions are also contemplated. And wall plate portion 108i has a fifth dimension 138 (i.e., width of aperture to expose toggle switch) of about one-half inch (0.5 in.), but other suitable dimensions are also contemplated.

In FIG. 7C, the wall plate portion 108j has a third dimension 140 (i.e., height between mounting screws) of about three and three-fourths inches (3.75 in.), but other suitable dimensions are also contemplated. The wall plate portion 108j has a fourth dimension 142 (i.e., height of aperture to expose electrical fixture) of about two and three-fourths inches (2.75 in.), but other suitable dimensions are also contemplated. And wall plate portion 108j has a fifth dimension 144 (i.e., width of aperture to expose electrical fixture) of about one and one-half inches (1.5 in.), but other suitable dimensions are also contemplated.

The wall plate portion 108k of FIG. 7D has a third dimension 146 (i.e., height between mounting screws) of about three and one-half inches (3.5 in.), but other suitable dimensions are also contemplated.

Turning to FIG. 7E, each of the wall plate portions 108h, 108i, 108j, and 108k, may have first depth dimension 148 (i.e., depth of entire wall plate portion) of between about one-eighth inch (0.125 in.) and about one inch (1 in.). In at least one exemplary case, a wall plate portion of a type described in the present disclosure has a first depth dimension 148 about one-quarter inch (0.25 in.). Each of the wall plate portions 108h, 108i, 108j, and 108k, may have second depth dimension 150 (i.e., depth of inner structures of the wall plate portion) of between about one-sixteenth inch (0.0625 in.) and about one-half inch (0.5 in.). In at least one exemplary case, a wall plate portion of a type described in the present disclosure has a second depth dimension 150 about one-eighth inch (0.125 in.).

FIGS. 7F-7I are various wall plate portions 108m-108p arranged as yet additional integral structures of one or more pest abatement wall plates. Each of the wall plate portions 108m-108p of FIGS. 7F-7I has non-operational (e.g., false, fake, illusory) screw heads added or integrally formed therein. The non-operational screw heads only appear to be screws that are used to secure a wall plate to an electrical fixture (e.g., outlet, switch, electrical box, or the like). Instead of using one or more screws, however, the wall plate portions 108m-108p, and other wall plate portions of the present disclosure, are secured via a wall plate securing structure and a mounting structure. The non-operational screw heads may be formed, for example, from metal, plastic, or any other suitable material. In at least one case, the non-operational screw heads are formed via a same injection molding process, and optionally via a same material, that forms the wall plate portion. Along these lines, in at least one case, the wall plate portion and optionally any one or more of the non-operational screw heads, the wall plate securing structure, a hinge, and a mounting structure are from via a single, same manufacturing process (e.g., injection molding or some process), and optionally via a same material (e.g., a plastic, such as polycarbonate, polyester, poly-chloride vinyl (PVC), acrylonitrile butadiene styrene (ABS), nylon, or any other suitable material). In one exemplary case, certain component structures of a pest abatement wall plate embodiment are formed of a tough, lightweight, elastic synthetic polymer with a protein-like chemical structure such as nylon.

Wall plate portion 108m is arranged as a wall plat portion to expose a standard duplex electrical outlet. Wall plate portion 108n is arranged as a wall plat portion to expose a pair of standard duplex electrical outlets. Wall plate portion 108o is arranged as a wall plat portion to expose three standard electrical toggle switches. And wall plate portion 108p is arranged as a wall plat portion to expose four standard duplex electrical outlets. Other standard wall plate portions may be arranged for phone jacks, coaxial cable jacks, and many other types of connectors, cables, power sources, and the like. Some standard wall plates portions are arranged as single-gang to cover a single electrical junction box; others cover two-gang, three-gang, or some other sized aperture through a building wall. In some cases, useful wall plate portions are solid structures with no apertures at all. Generally, each standard wall plate portion includes a user-facing outside surface and an inside surface that is hidden when the wall plate portion is adhered to a mounting structure or otherwise deployed. By way of example, one of skill in the art will understand that the pest abatement wall plate structures described in the present disclosure may have any suitable wall plate portion, and any such wall plate portion may have any type of pesticide hosting platform described herein. Optionally, such wall plate may also include any type of wall plate securing structure as described herein.

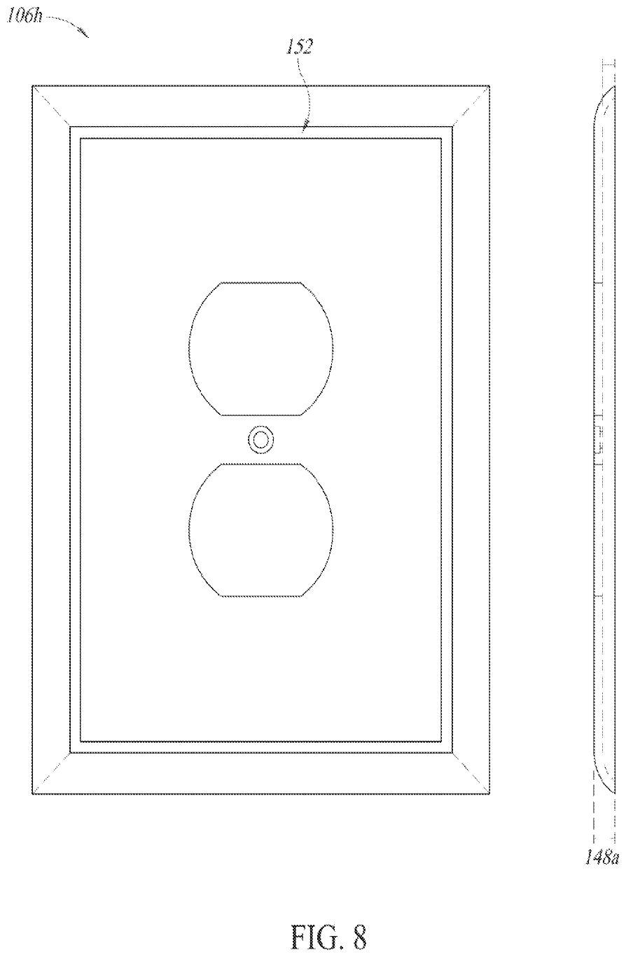

FIGS. 8-10 are additional embodiments of pest abatement wall plates

FIG. 8 is a front view of an eighth embodiment of a pest abatement wall plate 106h. The pest abatement wall plate 106h is an oversized wall plate arranged for placement over a conventional wall plate such as standard wall plate 10 of FIG. 1B. In such a configuration, the pest abatement wall plate 106h may have a first depth 148a that permits clearance between the back of pest abatement wall plate 106h and the face of the conventional wall plate. The pest abatement wall plate 106h may have a second depth 150a that permits contact or near contact between the pest abatement wall plate 106h and the face of the underlying conventional wall plate. In at least some cases, the pest abatement wall plate 106h has a gasket or gasket-like structure 152 (e.g., rubber, foam, fiber, or the like) with a soft perimeter at the second depth to permit coverage of more conventional wall plates. The gasket or gasket-like structure 152 may include apertures, cutouts, or other passageways for insects to travel from a room to a space behind the pest abatement wall plate 106h.

Pest abatement wall plate 106h may include one or more pesticide hosting platforms (not shown in FIG. 8) of any suitable size, shape, configuration, position, and the like. The hosting platform of pest abatement wall plate 106h may be arranged to receive a pesticide of any suitable type.

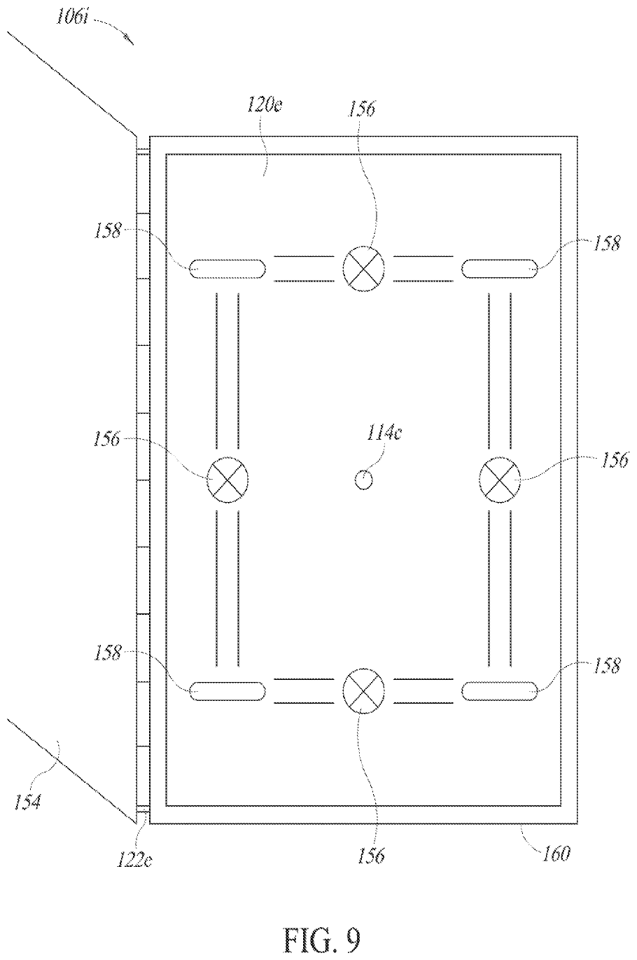

FIG. 9 is a front view of a ninth embodiment of a pest abatement wall plate 106i. The ninth embodiment is along the lines of wall plate embodiments 106b-106g of FIGS. 4-6. More particularly, pest abatement wall plate 106i includes a door 154 integrated with, or otherwise joined to, a wall plate mounting structure 120e via a hinge 122e. The hinge may include a hinge barrels, a living hinge, or any suitable structure that permits the door 154 of the pest abatement wall plate 106i to overlie the wall plate mounting structure 120e.

In at least one case, hinge 122e may include a latching structure formed with any suitable number of portions. For example, hinge 122e may include a first latch structure formed as a plastic boss or protrusion integrated or added to the hinge 122e, door 154, or mounting structure 120e. The first latch structure mates with a second latch structure formed as a second plastic boss, receptacle, hole, indent, or the like with or to the hinge 122e, door 154, or mounting structure 120e. In these or in the case of another type of latch structure, hinge 122e may bias door 154 into a temporarily closed position after the application of a small force, such as a force sufficient to close a plastic flip-top, a book, or some other similarly situated structure.

The mounting structure 120e of pest abatement wall plate 106i may be a solid structure, a substantially solid structure, a partially solid structure, or a structure formed with some other configuration. That is, in some cases, an electrical fixture such as electrical fixture 124a, 124b (FIG. 5) is accessible when the pest abatement wall plate 106i is deployed. In other cases, use of the pest abatement wall plate 106i entirely covers an electrical fixture and sacrifices use of the underlying electrical fixture. To achieve pest abatement, such sacrifice may be acceptable.

The mounting structure 120e of the pest abatement wall plate 106i is arranged as a pesticide hosting platform. For example, in the embodiment of FIG. 9, the mounting structure 120e includes a plurality of holes, shelves, grooves, protrusions, or other pesticide support structures 156 arranged to receive a pesticide. Also in the embodiment of FIG. 9, the mounting structure 120e includes a plurality of apertures or other passageways 158. These passageways 158, which maybe round, ovular, square, triangular, slits, grates, or passageways with some other configuration are arranged to permits pests to pass from behind the pest abatement wall plate 106i (e.g., from within an electrical box) to the mounting structure 120e or some other portion of the pest abatement wall plate 106i where the pesticide is hosted.

In some cases, the mounting structure 120e of the pest abatement wall plate 106i is mounted to an electrical fixture via a wall plate securing structure 114c of any suitable type. In some cases, the pest abatement wall plate 106i may include a relief portion 160 that is raised to clear an underlying electrical fixture (not shown in FIG. 9). The relief structure may be integrated with the mounting structure 120e or some other part of the pest abatement wall plate 106i. The relief portion 160 may in some cases be formed like the gasket or gasket-like structure 152 of FIG. 8.

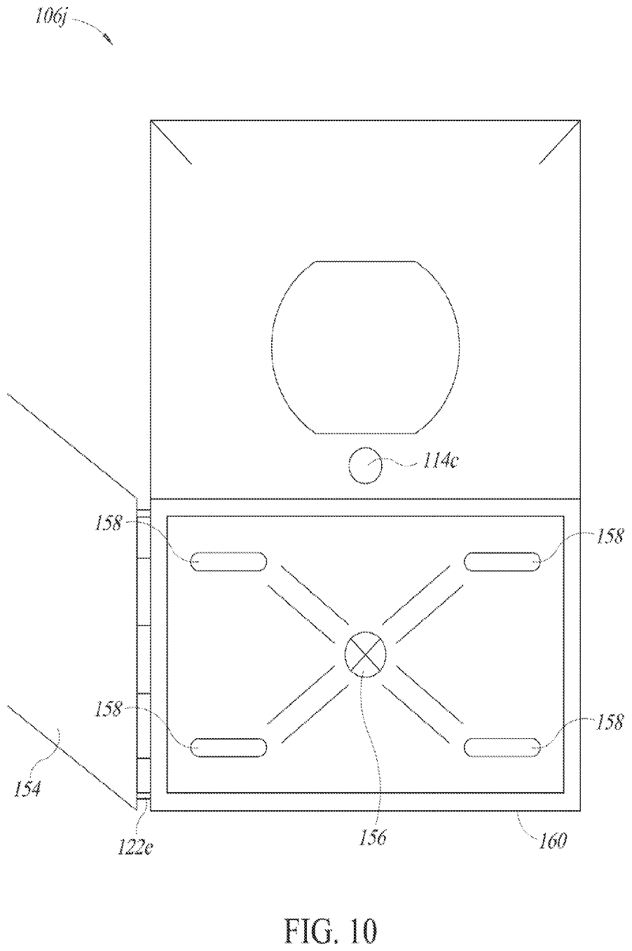

FIG. 10 is a front view of a tenth embodiment of a pest abatement wall plate 106j. The tenth embodiment is along the lines of ninth embodiment of a pest abatement wall plate 106i (FIG. 9) except rather than a door 154 in the ninth embodiment, the tenth embodiment has a half-door 154a. Other suitable door sizes, shapes, and configurations are of course contemplated too. By use of a half-door 154a, a compromise is achieved that permits a first portion of the electrical fixture (e.g., a top receptable of a duplex outlet) to be used without any disruption, and a second portion of the electrical fixture (e.g., a bottom receptacle of the duplex outlet) is obstructed in favor of a pest abatement platform.

As evident in the embodiment of FIG. 10, the tenth pest abatement wall plate 106j shares various structures with other pest abatement wall plate embodiments taught herein. Such structures, to avoid unnecessarily cluttering the present disclosure, are not further described.

FIG. 11A is a front view of an eleventh embodiment of a pest abatement wall plate 106k. The eleventh embodiment is along the lines of certain other embodiments of a pest abatement wall plate 106 except rather than a door 154, a half-door 154a, or the like, the eleventh embodiment includes an access door portion 154b. Certain features of other pest abatement wall plates 106a-j of the present disclosure may also be present in pest abatement wall plate 106k, but these features are not expressly identified to reduce the likelihood of cluttering or obfuscating other features of the present figure or otherwise confusing the disclosure.

The access door portion 154b may take any suitable shape, size, and configuration. Other suitable access door portion sizes, shapes, and configurations different from the embodiment of FIG. 11 are of course contemplated. Other suitable locations on the pest abatement wall plate 106k may be selected for placement of the access door portion 154b. For example, the access door portion 154b may be arranged on a top of the pest abatement wall plate 106k, on a side of the pest abatement wall plate 106k, or even on multiple parts of the pest abatement wall plate 106k.

An optional sixth pesticide hosting platform 110f embodiment is present or otherwise proximate on or near an inside surface of the access door portion 154b. The optional sixth pesticide hosting platform 110f embodiment may be or otherwise include an aperture through a portion of the pest abatement wall plate 106k. In some cases, the optional sixth pesticide hosting platform 110f embodiment is formed on one of the access door portion 154b and the pest abatement wall plate 106k, and in some cases, one or more parts of the optional sixth pesticide hosting platform 110f embodiment are formed on the access door portion 154b and one or more other parts of the sixth pesticide hosting platform 110f embodiment are formed on the pest abatement wall plate 106k.

FIG. 11B is another front view of the eleventh embodiment of a pest abatement wall plate 106k. In the view of FIG. 11B, the access door portion 154b has been separated from the main body of the eleventh embodiment of a pest abatement wall plate 106k. In some cases, the access door portion 154b is completely separable from the pest abatement wall plate 106k, and in other cases, the access door portion 154b is partially separable from the pest abatement wall plate 106k such as via a hinge or other structure contemplated herein. As evident in FIG. 11B, the sixth pesticide hosting platform 110f embodiment is optionally formed in entirely or in portions in the access door portion 154b, the pest abatement wall plate 106k, or both the access door portion 154b and the pest abatement wall plate 106k.

In the eleventh embodiment of FIG. 11, the access door portion 154b and the pest abatement wall plate 106k include one or more securing structures 162a-162d. In the present disclosure, the securing structures 162a-162d may individually or collectively be referred to as a securing structure 162. Along the lines of other securing structures described herein, the securing structures 162 may include, but are not limited to, apertures, magnets, studs, hook-and-loop structures, adhesive, bosses, slots, channels, ridges, friction structures, or some other securing means. In at least some cases, the access door portion 154b may slide on and off, “pop” on and off, tip in or out, open and close, or otherwise be temporarily and repeatedly removed from the pest abatement wall plate 106k at a first time and repeatedly rejoined or re-secured to the pest abatement wall plate 106k at a second later time. During a time of removal, the sixth pesticide hosting platform 110f may be inspected, tested, serviced, re-stocked with pesticide, or used in the performance of any other pest abatement act.

FIGS. 12A-12E are embodiments of access door portions 154c-154g. In FIG. 12A, the access door portion 154c includes tactile securing structures 162e, 162f. In operation, the tactile securing structures 162e, 162f on the external surface of the access door portion 154c may include one or more additional structures on the inside of the access door portion 154c which cooperate with complementary structures on the wall plate 108q. The tactile securing structures 162e, 162f may have any suitable size, configuration, textures, shape, and the like.

The access door 154d of FIG. 12B includes an optional seventh hosting platform 110g arranged on an inside surface of the access door 154d. In the embodiment of FIG. 12B, the hosting platform 110g is arranged as a clip to secure a determined pesticide to the inside surface of the access door 154d. In these and other cases, the hosting platform 110g on the access door 154d cooperates with the optional sixth hosting platform 110f, which is arranged as an aperture through the wall plate 106q. In some cases, the pesticide includes a bait to attract pests. In some cases, the pesticide additionally or alternatively includes a substance arranged to kill pests that come into contact with the substance.

In at least one case, a pesticide used in an embodiment such as the eleventh embodiment of a pest abatement wall plate 106q of FIGS. 11 and 12 includes a wood or wood-based pesticide that is appealing to a particular pest such subterranean termites. The pesticide could be a sap wood, soft wood, or some other wood or wood product. The pesticide may be nutritious to the pest or otherwise a source of “easy” energy. The pesticide may be fibrous, soft, nitrogen-rich, cellulose-rich, starch-rich, ethanol-rich, or inclusive of one or more other substances or characteristics desirable to the pest. The pesticide may take be arranged having any suitable size, shape, thickness, texture, moisture content, configuration, consistency, density, or other characteristics. In at least some cases, the pesticide of such embodiments may be formed as a dowel, a disk, a pellet, a chip, a plate, a block, a slice, or some other structure. In at least some cases, a pesticide may be clipped or otherwise adhered to the inside surface of the access door 154d. In at least some cases, the pesticide is formed as a disposable or one-time use pesticide that is deployed on an access door 154d for a first determined period of time and replaced with a new pesticide portion for a second determined period of time. In these or still other cases, an access door 154d may be arranged as a disposable product having a one-time portion of pesticide applied at a time of manufacturing. In such cases, after a determined period of time, a use may replace one access door 154d with a fresh access door 154d; each of the access doors 154d having a disposable pesticide formed thereon.

The access door 154e of FIG. 12C includes an optional eighth hosting platform 110h. Along the lines of the optional seventh hosting platform 110g of FIG. 12B, the optional eighth hosting platform 110h is arranged to host a pesticide. The optional eighth hosting platform 110h may include a tray, a well, an adhesive, a mechanical clip, a spring clip, or some other such securing means.

The access door 154f of FIG. 12D includes an optional ninth hosting platform 110i. Along the lines of other hosting platforms 110 of the present disclosure, the optional ninth hosting platform 110i is arranged to host a pesticide or otherwise invite a particular pest. The optional ninth hosting platform 110i may include one or more cylinders, tunnels, cavities, dowels, or the like arranged on or otherwise integrated with an inside surface of the access door 154f. In at least one case, cavities such as those disclosed in FIG. 12D are arranged to target a particular pest such as a termite.

In FIG. 12E, an access door 154g includes an optional tenth hosting platform 110j that is arranged with an adhesive. The adhesive may be a chemical-based adhesive, a tape, a hook-and-loop structure, or some other adhering means. In this way a pesticide of any suitable form, structure and the like may be desirably located proximate an electrical box, an inside wall structure, and the like.

Having now set forth certain embodiments, further clarification of certain terms used herein may be helpful to providing a more complete understanding of that which is considered inventive in the present disclosure.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a wall plate portion may be described as being formed or otherwise oriented “substantially vertical,” In these cases, a wall plate portion that is oriented exactly vertical is oriented along a “Z” axis that is normal (i.e., 90 degrees or at right angle) to a plane formed by an “X” axis and a “Y” axis (e.g., a floor in a room of a building). Different from the exact precision of the term, “vertical,” the use of “substantially” to modify the characteristic permits a variance of the “vertical” characteristic by up to 30 percent. Accordingly, a wall plate portion that is oriented “substantially vertical” includes a wall plate portion oriented between 63 degrees and 117 degrees. A wall plate portion that is oriented at 45 degrees of an X-Y plane, however, is not mounted “substantially vertical.” As another example, a wall plate portion having a particular linear dimension of “between about three (3) inches and five (5) inches” includes such devices in which the linear dimension varies by up to 30 percent, Accordingly, the particular linear dimension of the wall plate portion as conceived herein may be between one point five (1.5) inches and six point five (6.5) inches.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, the technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

In the present disclosure, when an element (e.g., a wall plate portion, a non-operational screw head, a mounting structure, or the like) is referred to as being “on,” “coupled to,” or “connected to” another element, the elements can be directly on, directly coupled to, or directly connected to each other, or intervening elements may be present. In contrast, when an element is referred to as being “directly on,” “directly coupled to,” or “directly connected to” another element, there are no intervening elements present.

The terms “include” and “comprise” as well as derivatives and variations thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the present disclosure, the terms first, second, etc., may be used to describe various elements, however, these elements are not be limited by these terms unless the context clearly requires such limitation. These terms are only used to distinguish one element from another. For example, a first machine could be termed a second machine, and, similarly, a second machine could be termed a first machine, without departing from the scope of the inventive concept.

The singular forms “a,” “an,” and “the” in the present disclosure include plural referents unless the content and context clearly dictates otherwise. The conjunctive terms, “and” and “or” are generally employed in the broadest sense to include “and/or” unless the content and context clearly dictates inclusivity or exclusivity as the case may be. The composition of “and” and “or” when recited herein as “and/or” encompasses an embodiment that includes all of the elements associated thereto and at least one more alternative embodiment that includes fewer than all of the elements associated thereto.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

The headings and Abstract of the Disclosure provided herein are for convenience only and do not interpret the scope or meaning of the embodiments.

The pest abatement wall plate systems, devices, and methods described in the present disclosure provide several technical effects and advances to the field of pest infestation.

Technical effects and benefits include the ability to reduce the number of pests found in a structure such as a living space. Reducing such pests, or eliminating them altogether, helps prevent the spread of disease, reduces the risk of electrical disruption, and reduces the risk of fire. Other technical effects and benefits may also be achieved. The inventors have recognized that undesirable insects are pests that gain access to interior building spaces through the electrical infrastructure of the structure. The pests may move freely within the walls of the structure, sometimes following the paths of electrical conduits constructed within the walls. The pests may pass through, nest, or otherwise congregate in electrical boxes, and the pests may gain access to the space inside the structure via a gap between a wall plate and its corresponding electrical box or via an aperture in the wall plate that is intentionally present to expose a portion of the electrical fixture (e.g., a toggle of a light switch) that is mounted in the electrical box. Systems, devices, and methods that reduce or eliminate pests are therefore desirable.

In at least one embodiment described in the present disclosure, a pest abatement wall plate includes a wall plate portion and a hosting platform. The hosting platform is used to stage a pesticide that undesirable pests may walk through, crawl through, touch, consume, or otherwise contact. The pesticide may exterminate the contacting pest directly in some cases. Alternatively, or in addition, a pest that contacts the pesticide may bring some or all of the pesticide to a nest or other location where two or more pests may be found, and this migration of pesticide acts to exterminate additional pests.

The present disclosure sets forth details of various structural embodiments that may be arranged to carry the teaching of the present disclosure. By taking advantage of the structures described herein, several exemplary devices, systems, and methods are now disclosed.

Example A-1 is a pest abatement wall plate, comprising a wall plate portion structured to cover an electrical box, the wall plate portion being formed substantially from a plastic material and having an inner surface and an outer surface, wherein the inner surface is adjacent to an inside volume of the electric box when the pest abatement wall plate is deployed; and a hosting platform proximate the inner surface of the pest abatement wall plate, the hosting platform arranged to stage a pesticide.

Example A-2 may include the subject matter of Example A-1, and alternatively or additionally any other example herein, wherein the pest abatement wall plate further comprises a mounting structure; and a hinge connecting the mounting structure to the wall plate portion.

Example A-3 may include the subject matter of Example A-2, and alternatively or additionally any other example herein, wherein the wall plate portion is arranged for placement about a standard duplex electrical outlet.

Example A-4 may include the subject matter of Example A-3, and alternatively or additionally any other example herein, wherein the wall plate portion is arranged for placement about a standard single pole toggle switch.

Example A-5 may include the subject matter of Example A-4, and alternatively or additionally any other example herein, wherein the wall plate portion is arranged for placement about a standard rectangular electrical fixture.

Example A-6 may include the subject matter of Example A-5, and alternatively or additionally any other example herein, wherein the electrical box is a single-gang electrical box.

Example A-7 may include the subject matter of Example A-6, and alternatively or additionally any other example herein, wherein the electrical box is a multi-gang electrical box.

Example A-8 may include the subject matter of Example A-7, and alternatively or additionally any other example herein, wherein the hosting platform is arranged as a well.

Example A-9 may include the subject matter of Example A-8, and alternatively or additionally any other example herein, wherein the hosting platform is arranged as a protuberance having a substantially planar surface that is substantially perpendicular to the inner surface of the wall plate portion.

Example A-10 may include the subject matter of Example A-9, and alternatively or additionally any other example herein, wherein the hosting platform and the wall plate portion are formed as a single structure.

Example A-11 may include the subject matter of Example A-10, and alternatively or additionally any other example herein, wherein the mounting structure has single aperture arranged to receive a screw, said screw arranged to secure the mounting structure to a central portion of a standard duplex outlet.

Example A-12 may include the subject matter of Example A-11, and alternatively or additionally any other example herein, wherein the mounting structure includes a first substructure having a first aperture arranged to receive a first screw and a second substructure having a second aperture arranged to receive a second screw, said first and second screws arranged to secure the mounting structure to first and second portions of an electrical switch.

Example A-13 may include the subject matter of Example A-12, and alternatively or additionally any other example herein, wherein the mounting structure is formed substantially from metal.

Example A-14 may include the subject matter of Example A-13, and alternatively or additionally any other example herein, wherein the mounting structure is formed substantially from a plastic.

Example A-15 may include the subject matter of Example A-14, and alternatively or additionally any other example herein, wherein the hosting platform is integrated with, or connected to, the mounting structure.

Example A-16 may include the subject matter of Example A-15, and alternatively or additionally any other example herein, wherein the hinge is has a piano hinge structure.

Example A-17 may include the subject matter of Example A-16, and alternatively or additionally any other example herein, wherein the hinge is a living hinge.

Example A-18 may include the subject matter of Example A-17, and alternatively or additionally any other example herein, wherein the wall plate portion, the mounting structure, and the hinge are formed as a single structure.

Example B-1 is a pest abatement wall plate, comprising a wall plate means structured to cover an electrical box, the wall plate means having an inner surface and an outer surface, wherein the inner surface is adjacent to an inside volume of the electrical box when the pest abatement wall plate is deployed; and a hosting platform means proximate the inner surface of the pest abatement wall plate, the hosting platform arranged to stage a pesticide.

Example C-1 is a method of pest abatement, comprising securing a mounting structure of a pest abatement wall plate to an electrical fixture that is mounted in an electrical box; applying a pesticide to a hosting platform of the pest abatement wall plate; and rotating a wall plate portion of the pest abatement wall plate to close the pest abatement wall plate and cover an open area of the electrical box.

The various embodiments described above can be combined to provide further embodiments. Aspects of the embodiments can be modified, if necessary to employ concepts of the various patents, application and publications to provide yet further embodiments.

In the description herein, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order to avoid obscuring the description with unnecessary detail. Thus, the present disclosure is not intended to be limited to the embodiments shown but is instead to be accorded the widest scope consistent with the principles and features disclosed herein. Hence, these and other changes can be made to the embodiments in light of the above-detailed description. In general, in the following claims, the terms used should not be construed to limit the claims to the specific embodiments disclosed in the specification but should be construed to include all possible embodiments along with the full scope of equivalents to which such claims are entitled. Accordingly, the claims are not limited by the disclosure.

1. A pest abatement wall plate, comprising:
a wall plate portion structured to cover an electrical box, the wall plate portion being formed substantially from a plastic material and having an inner surface and an outer surface, wherein the inner surface is adjacent to an inside volume of the electrical box when the pest abatement wall plate is deployed; and
a hosting platform proximate the inner surface of the pest abatement wall plate, the hosting platform arranged to stage a pesticide.

2. The pest abatement wall plate of claim 1, further comprising:
a mounting structure; and
a hinge connecting the mounting structure to the wall plate portion.

3. The pest abatement wall plate of claim 1 wherein the wall plate portion is arranged for placement about a standard duplex electrical outlet.

4. The pest abatement wall plate of claim 1 wherein the wall plate portion is arranged for placement about a standard single pole toggle switch.

5. The pest abatement wall plate of claim 1 wherein the wall plate portion is arranged for placement about a standard rectangular electrical fixture.

6. The pest abatement wall plate of claim 1 wherein the electrical box is a single-gang electrical box.

7. The pest abatement wall plate of claim 1 wherein the electrical box is a multi-gang electrical box.

8. The pest abatement wall plate of claim 1 wherein the hosting platform is arranged as a well.

9. The pest abatement wall plate of claim 1 wherein the hosting platform is arranged as a protuberance having a substantially planar surface that is substantially perpendicular to the inner surface of the wall plate portion.

10. The pest abatement wall plate of claim 1 wherein the hosting platform and the wall plate portion are formed as a single structure.

11. The pest abatement wall plate of claim 2 wherein the mounting structure has single aperture arranged to receive a screw, said screw arranged to secure the mounting structure to a central portion of a standard duplex outlet.

12. The pest abatement wall plate of claim 2 wherein the mounting structure includes a first substructure having a first aperture arranged to receive a first screw and a second substructure having a second aperture arranged to receive a second screw, said first and second screws arranged to secure the mounting structure to first and second portions of an electrical switch.

13. The pest abatement wall plate of claim 2 wherein the mounting structure is formed substantially from metal.

14. The pest abatement wall plate of claim 2 wherein the mounting structure is formed substantially from a plastic.

15. The pest abatement wall plate of claim 2 wherein the hosting platform is integrated with, or connected to, the mounting structure.

16. The pest abatement wall plate of claim 2 wherein the hinge has a piano hinge structure.

17. The pest abatement wall plate of claim 2 wherein the hinge is a living hinge.

18. The pest abatement wall plate of claim 2 wherein the wall plate portion, the mounting structure, and the hinge are formed as a single structure.

19. A pest abatement wall plate, comprising:
a wall plate means structured to cover an electrical box, the wall plate means having an inner surface and an outer surface, wherein the inner surface is adjacent to an inside volume of the electrical box when the pest abatement wall plate is deployed; and
a hosting platform means proximate the inner surface of the pest abatement wall plate, the hosting platform arranged to stage a pesticide.

20. A method of pest abatement, comprising:
securing a mounting structure of a pest abatement wall plate to an electrical fixture that is mounted in an electrical box;
applying a pesticide to a hosting platform of the pest abatement wall plate; and
rotating a wall plate portion of the pest abatement wall plate to close the pest abatement wall plate and cover an open area of the electrical box.
